(19) United States
(12) Patent Application Publication
(10) Pub. No.: US 2009/0175535 A1
(43) Pub. Date: Jul. 9, 2009

(54) IMPROVED PROCESSING OF MULTI-COLOR IMAGES FOR DETECTION AND CLASSIFICATION

(75) Inventor: Barry G. Mattox, Orlando, FL (US)

Correspondence Address: BIRCH STEWART KOLASCH & BIRCH, PO BOX 747, FALLS CHURCH, VA, 22040-0747, US

(73) Assignee: LOCKHEED MARTIN CORPORATION

(21) Appl. No.: 12/007,338

(22) Filed: Jan. 9, 2008

(51) Int. Cl. G06K 9/34

(52) U.S. Cl. 382/164

(57) ABSTRACT

The premise of this invention is that detection or classification of objects in a multi-color image depends on both the resolution and the signal-to-noise ratio (SNR) of the intensity of objects in the image, and can be aided significantly by reliable observation of the general coloring of the objects. The multi-color image may be derived from multiple wavebands, whether or not any of those wavebands lie in the visible light region, infrared region, etc. When detecting or recognizing objects in a color image, SNR information is more important than spatial resolution in the color component. Hence, color images such as RGB components are separated from an intensity image and processed with various noise reduction processes to reduce noise, i.e. increase SNR at the expense of spatial resolution. The intensity image is processed separately to enhance contrast of the image without degrading the spatial resolution. The processed color images and the intensity images are recombined to form a resultant multi-color image having increased SNR with minimum degradation of resolution.

### FIELD OF THE INVENTION

The present invention relates to image processing methods, systems, and algorithms that process multi-color (multi-band) images to enhance the visual impression for human perception or to improve the probabilities of detection and correct classification of targets by human observers and/or machine algorithms.

### BACKGROUND OF THE INVENTION

A. Introduction

As is well known, images often contain noise. Noise may be generated during the image capturing process (e.g., photon shot noise, dark current noise, or noise associated with the read-out electronics), during transmission (e.g., amplifier noise, communication channel noise), during encoding of the image for transmission, or during decoding of the encoded image after transmission.

Although noise can be mitigated by various techniques, it is difficult to completely remove all noise from an image. Moreover, noise degrades the image quality for human perception and for machine classification, thus hindering target detection and classification, for example.

Conventional techniques for improving target detection and classification include noise filtering. However, conventional spatial noise filtering algorithms reduce noise at the expense of image resolution. For example, a low-pass spatial filter smoothes out the noise, but also smears or otherwise degrades the image, resulting in a blurred or reduced-resolution image. Such a decrease in resolution also affects the ability of a target classification algorithm or human observer to accurately classify the target, particularly when the target is small or has fine details. The tradeoff of higher SNR for lower resolution when detecting relatively large objects may be negligible; however, detection or classification of smaller objects closer to the image resolution limit will be adversely affected by conventional noise-filtering algorithms.

B. Significance of SNR and Resolution in Relation to Detection

There are a number of image characteristics affecting human perception, such as signal-to-noise ratio (SNR), resolution, and dynamic range. Viewing conditions, such as background lighting or the quality of the display device being utilized, also affect the ability of a human to accurately detect a target. In general, detection accuracy of an object in an image increases as the SNR of the image increases. The Rose model was developed in the early days of radiology to relate detection accuracy to a quantifiable characteristic or the image (Burgess, A. E. “The Rose Model, Revisited,” Journal of Optical Society of America Vol. 16, No. 3, March 1999, pp. 633-646). Rose theorized that a SNR of 2 to 7 is required to allow a human observer to distinguish an object from the background. Rose's model in general is a simplistic approach where the background is not cluttered. According to Burgess, the ability of a human observer to accurately detect an object in a noisy image is directly relatable to SNR.

Furthermore, the resolution of the image-capturing device sets or determines a physical recognition limit. The physical characteristics of an image capturing device dictates how small of an object can be discriminated. For example, an image-capturing device with a 50 mm per pixel resolution can resolve an object no smaller than 50 mm. Thus, the greater the resolution of the image, the greater will be the detection capability for smaller objects. Classification of an object requires the ability of the imaging system to resolve the object so that the object shape can be perceived. This limits classification to objects with dimensions of several pixels or more.

Compared with the studies performed to predict the detection and classification capabilities of monochromatic imaging systems, there exists a more limited volume of work on detection and classification of objects in polychromatic (e.g., color) imagery. More specifically, while statistical models have been derived to reasonably predict the probability of detection or correct classification of objects in gray-scale images, reliable methods for similar predictions in polychromatic imagery are more elusive.

### SUMMARY OF THE INVENTION

The premise of this invention is that detection or classification of objects in a multi-color image depends on both the resolution and the SNR of the intensity of objects in the image, and can be aided significantly by reliable observation of the general coloring of the objects. Moreover, the resolution of the color information can be degraded significantly relative to the resolution of the intensity information before the onset of significant degradation of the detection or classification performance.

It is well known that for human perception, high spatial resolution of image intensity is much more important than high spatial resolution of image coloring. This principle is exploited, for example, in the encoding of NTSC, color television signals, which encodes sub-carrier color signals using a bandwidth of approximately one-third that of the monochrome (intensity) signal. (Resolution is dependent on bandwidth.)

The value of color in machine detection and classification of objects in a scene is much harder to quantify than parameters such as resolution and SNR of monochrome images. Qualitatively, one may argue that the overall color of an object is usually a useful feature in detection or classification, whereas in cases where monochrome details are not conclusive, color variations within the target are much less important than the predominant overall color.

If color imagery resolves the target into several pixels, all of which have a relatively low SNR, there is an opportunity to spatially filter the color components of the image, thereby improving the stability of the color of represented objects at the expense of relatively unimportant color spatial resolution. In parallel, the unfiltered color-components can be combined to form an intensity image that has the full resolution available in each of the unfiltered components, and has a SNR improvement due to the summing of the multiple colors (or bands). The spatially filtered color information can be subsequently re-imposed onto the higher resolution intensity image to form imagery that has both of the important characteristics for detection and classification: high-SNR and high-resolution in intensity, and stability of color (albeit with reduced color resolution).

A preferred embodiment of this invention is an image processing method comprising receiving a multi-color (or multi-band) image, separating the multi-color image into a color vector image and an intensity image, contrast enhancement processing of the intensity image, noise-filtering the color image to remove noise, and recombining the processed intensity image and the filtered color image to form a resultant multi-color image having increased SNR intensity (compared to each of the colors) and more stable color (compared to the original color image).

Alternately, the method and system of processing color components separately as described above may be used to combine the color image with another intensity image, such as a high-resolution infrared (IR) image. The IR image and color image preferably share the same imaging axis, i.e., the images preferably share the same field of view. This may be achieved with a boresighted IR and visual camera system.

Further scope of the applicability of the present invention will become apparent from the detailed description given hereinafter. However, it should be understood that the detailed description and specific examples, while indicating preferred embodiments of the invention are given by way of illustration only, since various changes and modifications within the spirit and scope of the invention will become apparent from this detailed description to those skilled in the art.

### BRIEF DESCRIPTION OF FIGURES

The present invention will become more fully understood from the detailed description given herein below and the accompanying drawings which are given by way of illustration only, and thus are not limitative of the present invention, and wherein:

FIG. 1. is a diagram of a system according to the invention including an input and output processor which interfaces with an image source, such as a camera or cameras, a CPU, a memory and a display;

FIG. 2 is a high level block diagram of the image processing method according to the invention where the input image is a noisy color (or multi-waveband) image;

FIG. 3 is a mid-level block diagram according to the invention, which separates color image information from intensity information and normalizes the color image based on the intensity information;

FIG. 4 is a mid-level block diagram according to the invention for enhancing contrast of the intensity information;

FIG. 5 is a mid-level block diagram for reducing noise in the color image;

FIG. 6 is a mid-level block diagram according to the invention for recombining the contrast-enhanced intensity image and the noise filtered color image;

FIG. 7 are sample images illustrating the operation of invention including a noisy input image, an intensity component, a color component, a filtered color image, and a recombined resultant image; and

FIG. 8 is a high level block diagram of an alternative embodiment of the invention that combines a low-SNR color image with a higher-SNR IR image.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents thereof.

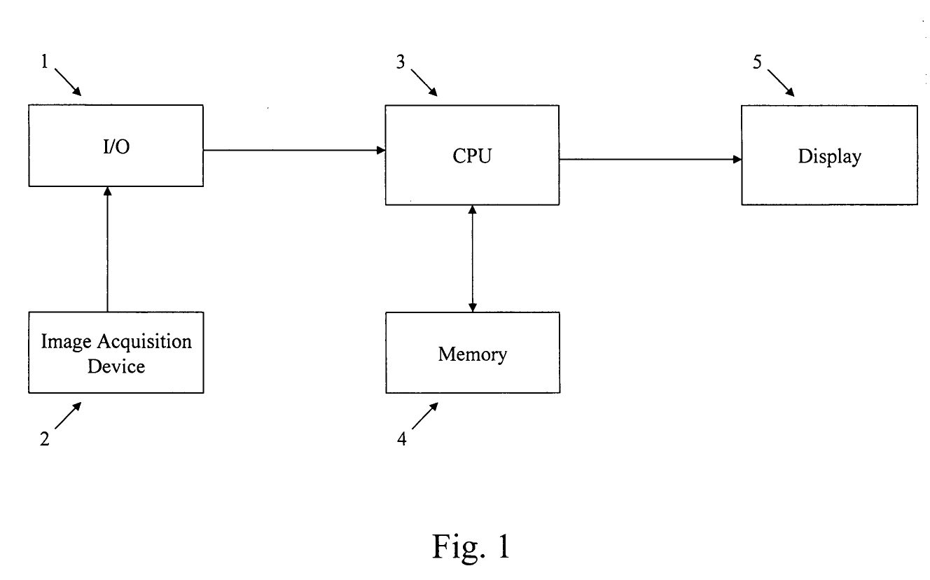

FIG. 1 illustrates a general purpose system that may be utilized to perform the methods and algorithms disclosed herein. The system shown in FIG. 1 includes an Input/Output (I/O) device 1, an image acquisition device 2, a Central Processing Unit (CPU) 3, a memory 4, and a display 5. This apparatus and particularly the CPU 2 may be specially constructed for the inventive purposes such as a specially programmed digital signal processor (DSP), an application specific integrated circuit (ASIC), a field programmable gate array (FPGA) or special purpose electronic circuit, or it may comprise a general-purpose computer selectively activated or reconfigured by a computer program stored in the memory 4. Such a computer program may be stored in a memory 4 which may be a computer readable storage medium, such as, but is not limited to, any type of disk (including floppy disks, optical disks, CD-ROMs, and magnetic-optical disks) or solid-state memory devices such as a read-only memory (ROM), random access memory (RAM), EPROM, EEPROM, magnetic or optical cards, or any type of computer readable media suitable for storing electronic instructions.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description herein. In addition, the present invention is not described with reference to any particular programming language. It will be appreciated that a variety of programming languages may be used to implement the teachings of the invention as described herein.

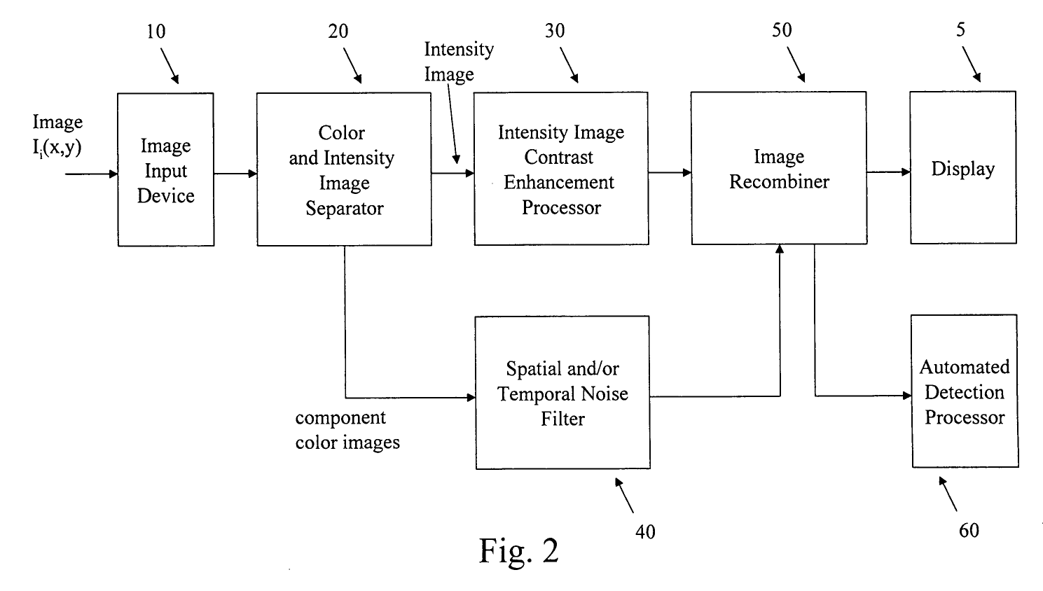

In a preferred embodiment of the invention, as shown in FIG. 2, an image processing system includes an image input device 10 that inputs an image into a color and intensity image separator 20, which separates the image into an intensity image and color components of the image. The input device 10 may be a conventional image acquisition device such as a color video camera, a color digital still camera, or a multi-band camera or cameras, such as infrared (IR) and ultraviolet (UV) sensors, etc.

The separated images are processed independently. The intensity image is processed with a contrast enhancement processor 30 and the color image is processed with a spatial and/or temporal noise filter 40. The contrast enhanced image and the noise filtered images are combined in image combiner 50. The resultant image may then be displayed on a display 5. The display 5 may be a conventional display device such as liquid crystal display (LCD), plasma screen, cathode ray tube (CRT), projection type display, head-mounted display device, etc.

The image input device 10 and the display 5 may be remote from or collocated with the rest of the image processing system. For example, the image input device may be mounted on an aircraft that transmits the input image to the separator 20 which may be located with the other components of the system at a ground station. Furthermore, the display may be a cockpit heads-up display viewed by a pilot of the aircraft sensing the target, a display of an operator in another aircraft such as an AWAC (Airborne Warning and Control), or a display of a ground-based control station. In addition or as an alternative, the resultant image or image components may be applied to an automated detection processor 60.

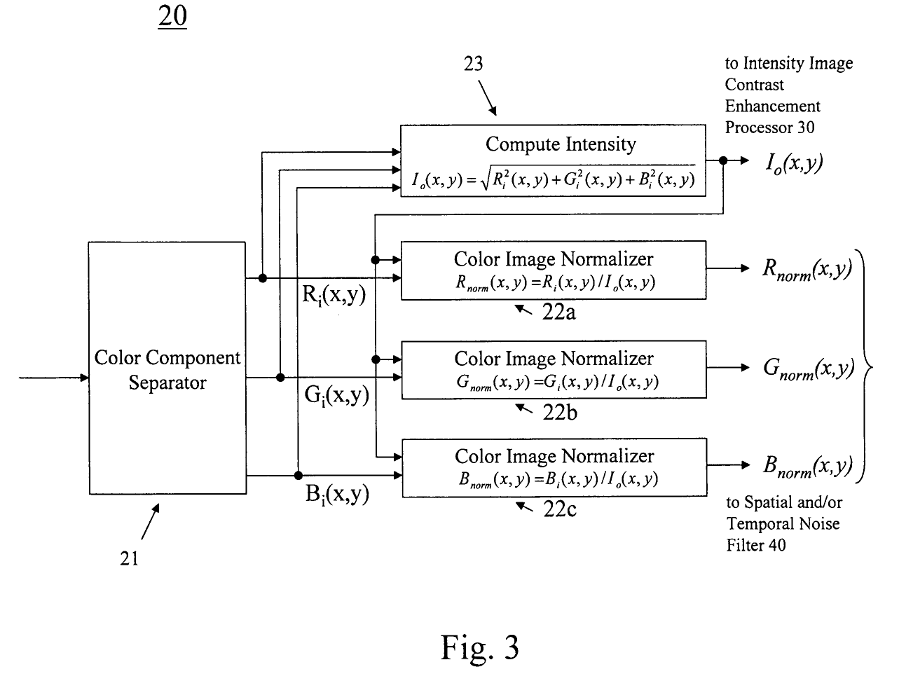

The color and intensity image separator 20 separates intensity and color components of the noisy input image. More specifically the separator 20 may perform a specific separation process as shown in FIG. 3. A color component separator 21 separates individual color components, e.g., R, G, B components, of the noisy input color image. The intensity image of the noisy image may be determined by an intensity determination device 23 using for example a root mean square of the color components as follows:

I(x,y)=\sqrt{R²(x,y)+G²(x,y)+B²(x,y)} (1)

where I(x,y) represents intensity of the noisy image and R(x,y), G(x,y), and B(x,y) are red, green, and blue color components of the noisy image respectively. Other methods for deriving an intensity image may also be used, such as adding the R, G, and B components without squaring. The inventor recognizes that there may be variations in construction of intensity and color component images. An important characteristic of the invention is the separate processing of intensity and color components, with the intensity component maintaining the higher resolution and the color components trading resolution for stability (higher SNR).

Although the primary color components R, G, B are used to define I(x,y) above, the I(x,y) intensity image may be derived from other color frequencies and is not restricted to exactly three colors, or to the primary colors or any color space in particular. The color components are then normalized with a color image normalizer 22a, 22b, 22c that removes most if not all of the intensity dependence from the resulting color components. In an RGB system, the normalizer may implement the following:

$${R}_{norm} ( x , y ) = \frac{R ( x , y )}{I ( x , y )} \\ {G}_{norm} ( x , y ) = \frac{G ( x , y )}{I ( x , y )} \\ {B}_{norm} ( x , y ) = \frac{B ( x , y )}{I ( x , y )} \qquad ( 2 )$$

where Rₙₒᵣₘ(x,y), Gₙₒᵣₘ(x,y), and Bₙₒᵣₘ(x,y) are normalized primary color components, for example.

The separated intensity and color images are preferably processed independently. The intensity image may be processed in processor 30 to enhance the contrast of the image without degrading the resolution. The color image components are processed with a noise filter 40 at the expense of degrading the overall spatial and/or time resolution of those image components. Finally, the processed intensity and color images are recombined by a dot product or point-by-point multiplication of the pixels in the combiner 50.

It should be noted that other representations of color imagery may alternately be employed with similar efficacy. One example of alternate color coding is YCC, having components of intensity Y, color difference signal Cr, and color difference signal Cb. An example of this color encoding, related to the RGB components is as follows:

Y(x,y)=0.299·R(x,y)+0.587·G(x,y)+0.114·B(x,y)

Cb(x,y)=−0.169·R(x,y)−0.331·G(x,y)+0.500·B(x,y)

Cr(x,y)=0.500·R(x,y)−0.418·G(x,y)−0.082·B(x,y) (3)

In this case, the intensity signal is Y and the two color components to be processed (filtered) separately are Cb and Cr and these components would be generated by the separator 20. Reconstruction by 50 of the RGB signals used in most displays is as follows:

R(x,y)=Y(x,y)+1.402·Cr(x,y)

G(x,y)=Y(x,y)−0.346·Cb(x,y)−0.715·Cr(x,y)

B(x,y)=Y(x,y)+1.771·Cb(x,y) (4)

In the discussions that follow, the Cb and Cr color components would be filtered in a fashion similar to the filtering of the Rₙₒᵣₘ, Gₙₒᵣₘ, and Bₙₒᵣₘ images and the Y image would be processed in a manner similar to that of the I image of the RGB system.

### 1. Intensity Image Processing

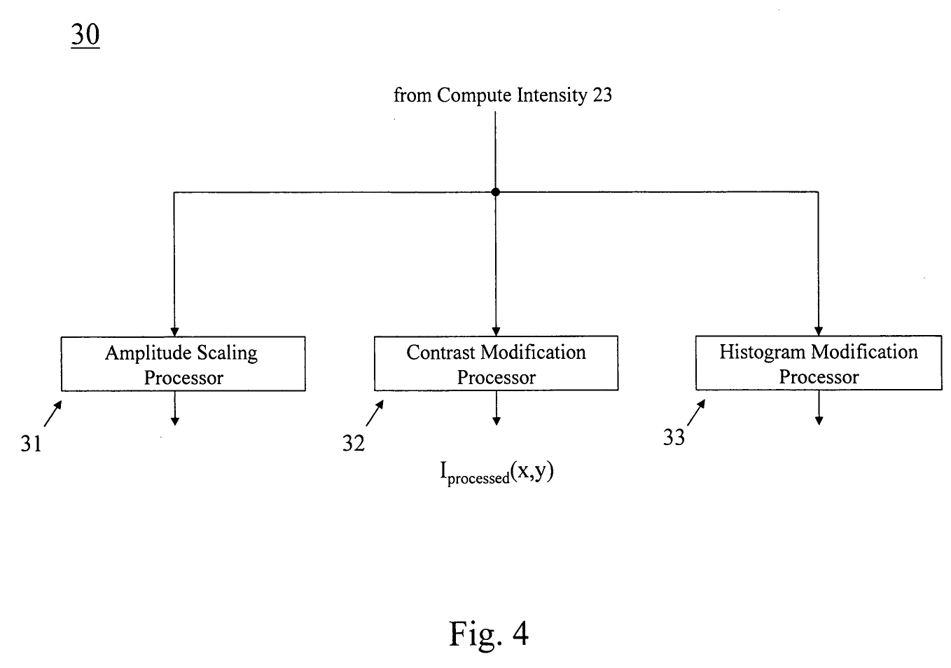

In FIG. 4, the intensity image contrast enhancement processor 30 is described in greater detail. Many different types of image contrast enhancement can be tailored to extract features with varying image conditions, e.g., noise being Gaussian versus “popcorn” noise, white versus colored, low dynamic range of contrast due to low illumination, etc. Certain types of image processing may enhance visual perception or detection, such as edge enhancement. Generally, in the intensity image processing, it is desirable to maintain the high resolution. Because the intensity image contains contributions from all bands (e.g., R, G, and B), its SNR will generally be greater than the SNR of the color components. Therefore, the intensity image may be processed to enhance the image contrast but spatial filtering that would degrade resolution would be much less desirable in the intensity image than in the color components. If SNR enhancement of the intensity image is required, consideration of integration of multiple time-sequential image frames might be considered, with image motion being a limiting factor.

An overexposed or underexposed image suffers from poor image contrast. In addition, an image with a target having similar absorption characteristics (for through-transmission-based imagery) or adsorption characteristics (reflective-based imagery) compared to the background also suffers from poor contrast. Well known contrast enhancement techniques may be used by the invention, such as amplitude scaling (amplitude scaling processor 31) or histogram modification (histogram modification processor 33) for under-exposed or over-exposed images. Contrast modification (contrast modification processor 32) may be used for poor foreground to background differentiation. The disclosure of this invention does not include the specifics or particulars of the processing that is done in step 30, such as the above-mentioned techniques, or other techniques, such as non-linear noise reduction (e.g., median filtering), image contrast mapping, amplitude scaling, histogram modification, or time-sequential frame integration since each of these processes is conventional by itself. However, it is recognized that one or more such enhancements may be employed to advantage in this stage of the processing as a complement to the essential advantages of this invention, that of separating and maintaining a high-resolution intensity image (whether enhanced or not) from the color components of the image, which are to be filtered to reduce noise at the expense of lesser important spatial and/or time resolution in the color components.

### 2. Color Image Processing:

Color images may contain more noise than intensity or gray scale images of the same object, due to the division of the light energy collected for a single pixel into multiple bands (colors). The noise component of each of the color images tends to be independent of the others, whether obtained in a digital system such as charged-coupled device (CCD) or Complementary metal-oxide-semiconductor (CMOS), or in analog film. Image noise in general may be created from the imaging source (film grain noise, optical coupling, electronic noise, thermal noise, photon shot noise, etc.) or from noise added during transmission of the image data. Since the intensity image is a combination of the color (band) images, each having independent noise components, the intensity image will have a higher SNR than each of the color images that were combined.

The inventive solution to reduce the noise and therefore increase the SNR of the final color image is to separate the color components and process the colors separately to reduce or remove noise. For example, using the primary colors (RGB) in a typical color image, each of color components is separated from the original image as described above for the color and intensity image separator 20. Each color component is processed with any of the following noise reduction techniques.

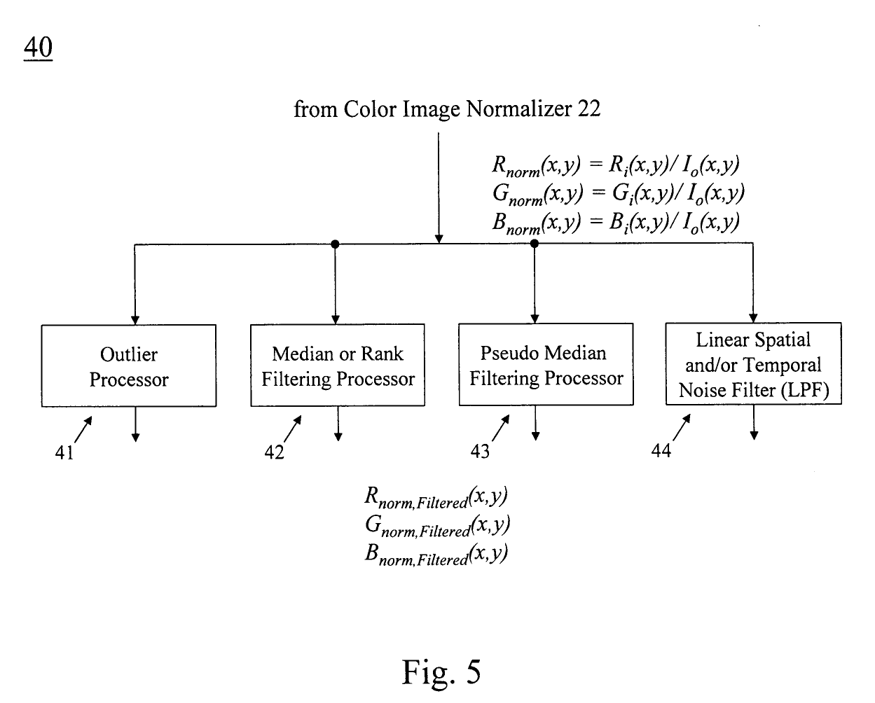

The descriptions in the following sections and in reference to FIG. 5 are specific noise reduction processes that are designed to remove different types of noise. It should be noted that the noise reduction process will seldom achieve complete removal of noise and may result in a reduction of color resolution. However, resolution of the color components is much less important than resolution in the intensity image. The stability (SNR) of the color image component is typically much more important than the resolution for perceptual enhancement or for forming features for automatic target detection or classification algorithms. In the following sections, the noise will be modeled as either nearly Gaussian or as a particularly non-Gaussian noise process (e.g., ignition or popcorn noise).

a. Linear Noise Cleaning Process by Spatial Filtering

The noise in an image generally is spatially decorrelated or “white”, whereas the signal components are more heavily weighted in the lower-frequency regions than in the higher-spatial-frequency regions. Thus, an effective way to remove noise is to apply a low pass filter (LPF) 44. This technique eliminates much more noise power than it eliminates in signal power, thus improving the SNR. However, it also reduces the spatial resolution of the image. This tradeoff of resolution for SNR is advantageous for the color components, for which resolution is less important than in the intensity image. In the spatial domain, a simple but effective M×N low-pass filter may be employed by convolving the image with a filter array. The impulse responses of two examples of simple 3×3 filters H are given below.

$$\begin{matrix}H = \frac{1}{N} ⌊ \begin{matrix}1 & 1 & 1 \\ 1 & 1 & 1 \\ 1 & 1 & 1\end{matrix} ⌋ & ( 5 ) \\ H = \frac{1}{{( b + 2 )}^{2}} ⌊ \begin{matrix}1 & b & 1 \\ b & {b}^{2} & b \\ 1 & b & 1\end{matrix} ⌋ & ( 6 )\end{matrix}$$

Such filters may be extended to larger M×N arrays. The more M and/or N is increased, the more detail information is lost in the X and Y dimensions, respectively. That is, there is an increased loss of resolution or blurring effect due to the low-pass filter. The benefit is that the SNR is increased. For example if an M×N uniform filter is used, such as the example in (5) above, the SNR of each color component is increased by a factor of (M·N)^{1/2}.

Of course, the filtering process can be implemented in the Fourier space. Filtering in the spatial domain can be computationally intensive and it may be beneficial to process in the spatial-frequency domain instead, especially if the masking window is much larger than 3×3. Although the result is the same, the nature of the noise characteristic can be readily seen in spatial-frequency space. Thus, the selection of the cutoff frequency employed by low-pass, high-pass, and/or band-pass filters can be more easily analyzed and adjusted to selectively reduce noise while causing minimal deterioration of the original image. Other filters, such as Butterworth or Chebychev, can be used here as well. An important aspect of the invention is not the exact filter constructions, but that the filtering operates on the color images separately from the intensity image so that the loss of resolution due to the SNR enhancement does not degrade the resolution of the intensity image, which determines the perceived resolution of the final reconstructed image after the image combiner (50).

b. Linear Noise Cleaning Process by Temporal Filtering

Alternatively, a linear noise cleaning process may be achieved either spatially and/or temporally with linear spatial and/or temporal noise filter 44. Whether or not the noise in an image is spatially decorrelated or not, it is usually decorrelated frame-to-frame, whereas the signal components are highly correlated frame-to-frame with the frame-to-frame correlation times limited by the motion of the image. Thus, the color images may be additionally temporally filtered frame-to-frame. The simplest implementation method for performing this operation would be a pixel-by-pixel recursive low-pass temporal filter, such as

Rfilteredₙ(x,y)=α·Rfilteredₙ₋₁(x,y)+(1−α)·Rₙ(x,y)

Gfilteredₙ(x,y)=α·Gfilteredₙ₋₁(x,y)+(1−α)·Gₙ(x,y)

Bfilteredₙ(x,y)=α·Bfilteredₙ₋₁(x,y)+(1−α)·Bₙ(x,y) (7)

where n denotes the current frame time, and n−1 is the previous frame time. The effective filter bandwidth is determined by the value of α. The increase in SNR due to the temporal filtering is the square-root of the effective number of integrated frames N, where N=1/(1−α). If no motion is present over the N frames, there is no loss of resolution due to the filtering. To the extent that objects in the scene move by k pixels during the integration time, there is a smearing effect on the order of k pixels, causing a loss in resolution in the color images in the portion of the scene in which the motion occurs. Note that either spatial filtering, temporal filtering, or both may be used to reduce noise in the color images.

The intensity image does not experience the smearing effect just described unless the intensity image is itself similarly filtered. Since smearing of the intensity image is much more critical than that of the color images, temporal filtering of the intensity image, if used, preferably should be designed with a lower value of integrated frames, N, so that motion smearing of the intensity image is traded off for SNR and the fact that human perception also has limitations in its ability to follow rapid motion.

c. Nonlinear Noise Cleaning Process

In the previous section, the noise in the image was modeled as an additive noise, such as nearly Gaussian noise. However, for noise sources that result in highly non-Gaussian noise (ignition noise, for example), a nonlinear noise cleaning process may be more effective than linear filtering for improving the SNR of the color images. The descriptions in the following sections and in reference to FIG. 5 are examples of specific non-linear noise reduction processes such as outlier processor 41, medical or rank filtering processor 42, and pseudo median filtering processor 43. However, these non-linear noise cleaning processes are not limited to the examples listed.

1) Outlier

The outlier noise cleaning technique using an outlier processor 41 compares the pixel of interest to its neighborhood average (e.g. the average of the 8-neighboring pixels). An example of the outlier utilizes the masking window below to form an average value and utilizes a predetermined threshold to replace the atypical-amplitude center pixel or “outlier” by the average of the 8-neighborhood pixels.

$$H = \frac{1}{8} ⌊ \begin{matrix}1 & 1 & 1 \\ 1 & 0 & 1 \\ 1 & 1 & 1\end{matrix} ⌋ \qquad ( 8 )$$

As with low-pass linear filtering, the process can smear the image, causing loss of image detail. However, the replacement would only occur if the center pixel differs from the mean of the 8-neighborhood pixels by the threshold value. The threshold can be very effective in correcting noise with large amplitude distribution tails with little degradation in resolution. Of course, configurations other than the illustrated 3×3 mask may be used with similar results.

2) Median or Rank Filtering

Another non-linear noise filtering process that may be used by the invention involves median or rank filtering using a median or rank filtering processor 42. In an M×M matrix, where M is an odd integer, the pixels values are ranked and determine the median value. Median filtering is particularly useful to reduce speckle noise. Such speckle noise occurs frequently, either due to over exposure or random noise from the detection source. This type of noise is often unavoidable and causes degradation not only in the saturated pixel but the surrounding pixels as well. By using median filtering, the pixel values with abnormally high or low intensity value can be replaced with a median pixel value of the neighborhood pixels, thus effectively attenuating noise. However, median filtering is time consuming computationally, especially if the window size is large.

3) Pseudo Median Filtering

An alternative to median or rank filtering that may speed up the process time is to use pseudo median filtering processor 43. Instead of replacing the high intensity pixel with a median pixel value of the M×M window, the median is calculated by averaging two or more adjacent pixel values. Thus, processing time for ordering or ranking the pixel value is cut at least by factor of 2. Although, this causes more smearing effects than the median filter, it does shorten the processing time in a beneficial manner.

### 3. Image Recombination

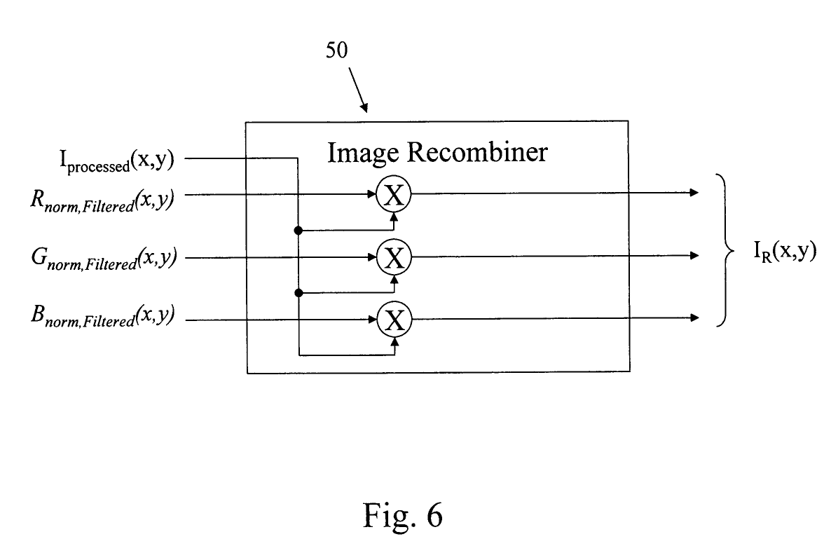

The form of the image recombiner (50) of FIG. 3 depends on the method of representing the color information. The relationships for transforming between the YCC and RGB methods for representing color images are shown in equations (3) and (4). The equations for recombining the color images (or filtered color images) with the intensity image to form the final recombined color image depends on the method used (e.g., YCC, RGB, or some other representation). FIG. 6 shows, for the RGB method, a recombination processor to recombine the intensity image with normalized RGB images that have been filtered to improved SNR. The recombination step is a simple point-by-point multiplication of each color 2D image data with processed intensity image. The result from the recombiner 50 may be displayed on the display 5 for detection by a user or sent to a target classification or detection algorithm.

Rₒᵤₜ(x,y)=R_{norm,Filtered}(x,y)·I_{processed}(x,y)

Gₒᵤₜ(x,y)=G_{norm,Filtered}(x,y)·I_{processed}(x,y)

Bₒᵤₜ(x,y)=B_{norm,Filtered}(x,y)·I_{processed}(x,y) (9)

When the YCC method of encoding color is used, the image recombiner 50 for combining the intensity Y with the filtered C_{b} and Cᵣ images would take the form of equation (4), and the result would be an RGB representation commonly used in displays.

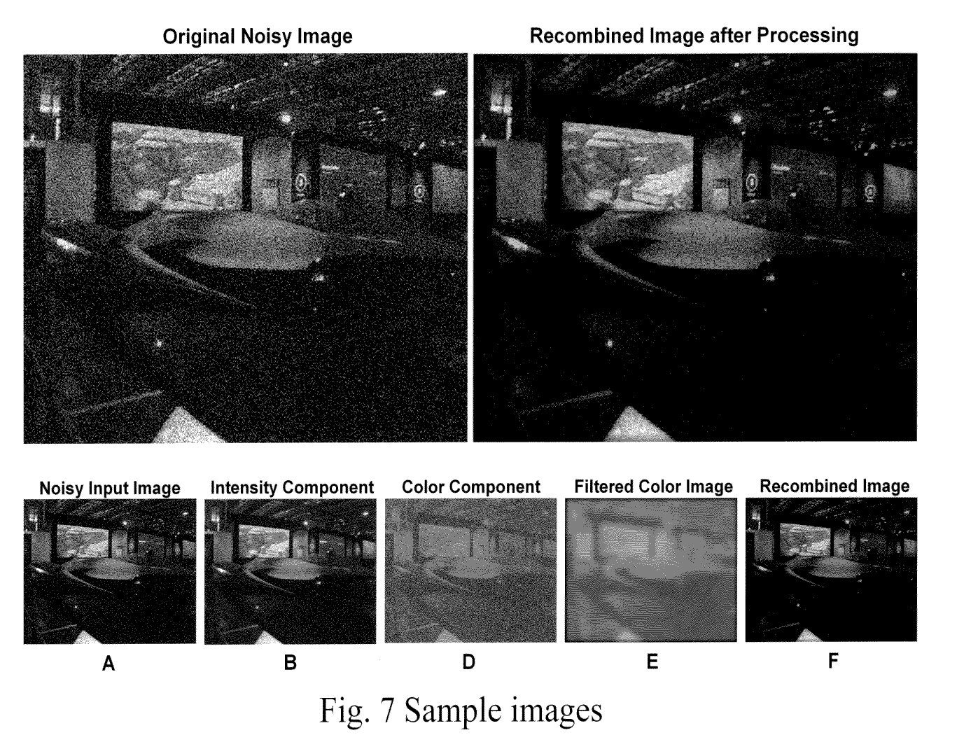

FIG. 7 illustrates sample images from each step described in the present invention. The image A represents a noisy color input image. The image B is the intensity component of the noisy color input image A. The image D is an image formed from the normalized RGB color components of the noisy image. The image E is the filtered color image where the resolution of the image is extremely poor but the speckle noise shown in image D is greatly reduced. The image F is the output of the recombination step, where the result shows a high resolution image with greater SNR of the color component. This embodiment of the invention is in its simplest form, executing only equations (1), (2), (5), and (9), where the filter of equation (5) is a 17×17 uniform filter. No processing of the intensity image was used in this example.

### 4. Dual Image Source Combination

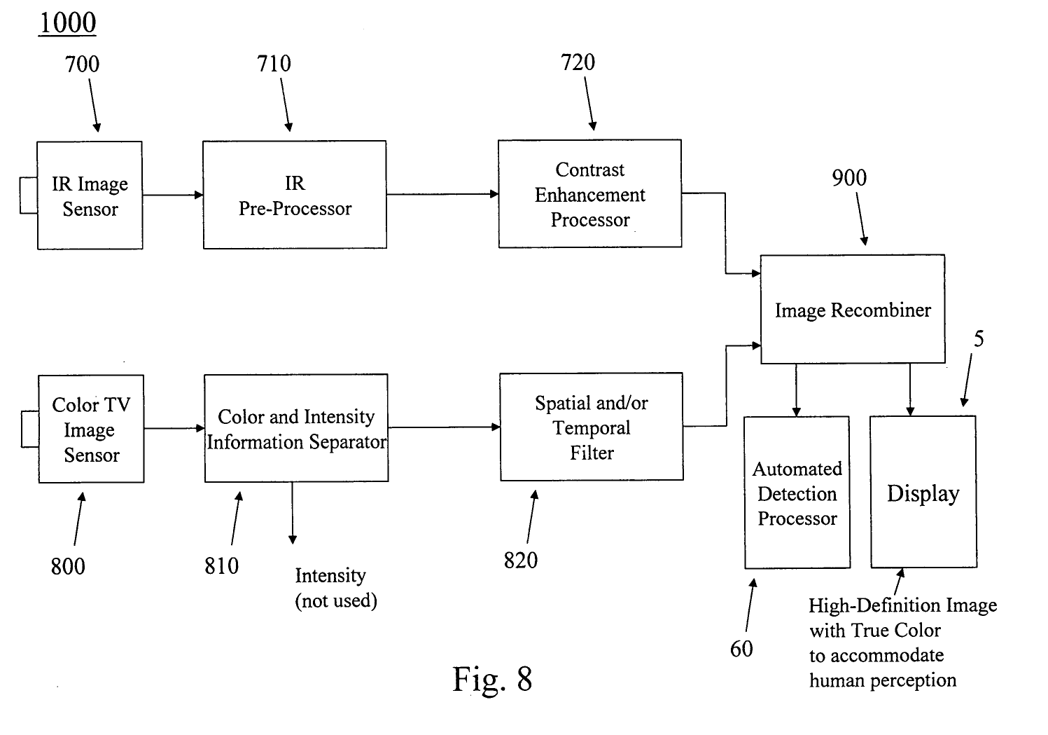

FIG. 8 illustrates an alternative embodiment of the invention, a dual image source combination processor 1000 where the image data is obtained from a boresighted IR and visible imager. Boresighted IR is defined as two imaging systems sharing the same imaging axis so that both the IR and visible images contain the same scene. Here, the IR image captured from an IR camera 700 is a high-resolution or high-definition image with typically much higher SNR than the color images. Under low-light conditions, the visible light camera 800 produces relatively low SNR color imagery. The color image goes through a similar process as in FIG. 1 where the color image is separated to RGB or YCC components with a color and intensity information separator 810. The color image separation processor 810 separates color components based on equations (2) for RGB and equation (3) for YCC. The color components are then processed with a spatial and/or temporal filter 820 to reduce noise.

The IR input image from the IR image sensor 700 is processed with IR pre-processor 710. The IR pre-processor is a conventional image process which may include non-uniformity correction, frequency equalization, resizing image by zero-padding, or cropping to a desired image size. However, the IR pre-processor is not limited to the processes listed above.

The pre-processed IR image is then processed to enhance contrast with a contrast enhancement processor 720. The contrast enhancement processor may include normalization or amplitude scaling, contrast modification, or histogram adjustment processes. However, the contrast enhancement processor may utilize other known image processing techniques and is not limited to the examples listed above.

The contrast enhanced IR image is then combined with noise filtered color components with an image recombiner 900. The final resultant image is displayed on a display 5. The final resultant image may be subject to further processing with an automated detection processor 60. The automated detection processor 60 may employ conventional techniques known in the art, e.g., pattern classification algorithms, motion detection, or edge detection operations for detecting, classifying, and/or recognizing objects in a scene.

The dual image source combination processor 1000 does not utilize the visible intensity data in the recombination step. Instead, the high resolution IR image is combined with the processed color image to create a true color high definition image to further increase the detection of a target while accommodating human perception. If machine classification algorithms are used, the color information becomes a valuable classifier feature. Again, the image enhancement of IR and color images is performed separately.

The processed color components are combined with the processed IR image to create a true-color, high definition, SNR-enhanced image that improves target detection and/or classification

The recombination of color and IR images for the RGB color system is given by

Rₒᵤₜ(x,y)=R_{norm,Filtered}(x,y)·IR_{processed}(x,y)

Gₒᵤₜ(x,y)=G_{norm,Filtered}(x,y)·IR_{processed}(x,y)

Bₒᵤₜ(x,y)=B_{norm,Filtered}(x,y)·IR_{processed}(x,y) (10)

Recombination using the YCC color system is given by equation (4) with intensity Y replaced by IR_{processed}.

Although the description of the present invention deals with target detection/classification, the application of the method and system would apply in various fields, including motion picture processing, medical imaging, etc.

### 5. Automated Detection Algorithm

Furthermore, the resultant images with improved SNR may be applied with an automated detection system. Such detection/classification algorithms are not the subject of this invention. However the improved color stability provided by this invention can be used to improve performance when classification algorithms are employed that derive features based on color.

The invention being thus described, it will be obvious that the same may be varied in many ways. Such variations are not to be regarded as departure from the spirit and scope of the invention, and all such modifications as would be obvious to one skilled in the art are intended to be included within the scope of the following claims.

1. An image processing method comprising:
receiving a multi-color image;
separating the multi-color image into a color image and an intensity image;
contrast enhancement processing, if applied, processes the intensity image to enhance contrast that does not significantly degrade resolution of the intensity image;
noise filtering the color image of the multi-color image to remove noise, and
recombining the processed intensity image and the filtered color image to form a resultant multi-color image having increased SNR as compared with the received multi-color image.

2. The image processing method as in claim 1, further comprising displaying the resultant multi-color image.

3. The image processing method as in claim 1, further comprising separating the color image into a plurality of color components and normalizing the plurality of color components with the intensity image.

4. The image processing method as in claim 1, wherein said contrast enhancement processing the intensity image includes at least one of thresholding, amplitude scaling, contrast modification, or histogram modification.

5. The image processing method as in claim 1, wherein said noise filtering includes at least one of low pass filtering, band pass filtering, high pass filtering, outlier filtering, median filtering, or pseudomedian filtering.

6. The image processing method as in claim 1, wherein said recombining the processed intensity information and the filtered color information is a dot product.

7. The image processing method as in claim 1, wherein the multi-color image is a visible image.

8. The image processing method as in claim 7, wherein the intensity image is based on a boresighted image from outside the visible spectrum.

9. An image processing system, comprising;
a receiver that receives a multi-color image;
a separator operatively connected to said receiver, said separator separating the multi-color image into a color image and an intensity image;
a contrast enhancement processor operatively connected to said receiver, said contrast enhancement processor, if applied, enhancing the contrast of the intensity image without significantly degrading resolution of the intensity image;
a noise filter operatively connected to said receiver, said noise filter filtering the noise from the color image of the multi-color image, and
a recombiner operatively connected to said receiver, said recombiner recombining the processed intensity image and the filtered color image to form a resultant multi-color image having increased SNR as compared with the received multi-color image.

10. The image processing system as in claim 9, further comprising a display operatively connected to said receiver, said display displaying the resultant multi-color image.

11. The image processing system as in claim 9, wherein the separator further comprises a color image normalizer that normalizes the plurality of color components with the intensity image.

12. The image processing system as in claim 9, wherein said contrast enhancement processor includes as least one of a threshold processor, an amplitude scale processor, a contrast modification processor, or a histogram modification processor.

13. The image processing system as in claim 9, wherein the said noise filter includes as least one of a low pass filter, a band pass filter, a high pass filter, an outlier filter, a median filter, or a pseudomedian filter.

14. The image processing system as in claim 9, wherein said recombiner is a dot product processor.

15. The image processing system as in claim 9, wherein the multi-color image is a visible image.

16. The image processing system as in claim 15, wherein the intensity image is based on a boresighted image from outside the visible spectrum.

17. A computer-readable storage medium having a computer program stored therein, the computer program when executed causes a computer to perform an image processing method including:
receiving a multi-color image;
separating the multi-color image into a color image and an intensity image;
contrast enhancement processing, if applied, processes the intensity image to enhance contrast without significantly degrading resolution of the intensity image;
noise filtering the color image of the multi-color image to remove noise, and
recombining the processed intensity image and the filtered color image to form a resultant multi-color image having increased SNR as compared with the received multi-color image.

18. The computer-readable storage medium as in claim 17, further comprising displaying the resultant multi-color image.

19. The computer-readable storage medium as in claim 17, further comprising separating the color image into a plurality of color components and normalizing the plurality of color components with the intensity image.

20. The computer-readable storage medium as in claim 17, wherein said contrast enhancement processing the intensity image includes at least one of thresholding, amplitude scaling, contrast modification, or histogram modification.

21. The computer-readable storage medium as in claim 17, wherein said noise filtering the normalized color components includes at least one of low pass filtering, band pass filtering, high pass filtering, outlier filtering, median filtering, or pseudomedian filtering.

22. The computer-readable storage medium as in claim 17, wherein said recombining the processed intensity information and the filtered color information is a dot product.

23. The computer-readable storage medium as in claim 17, wherein the multi-color image is a visible image.

24. The computer-readable storage medium as in claim 23, wherein the intensity image is based on a boresighted image from outside the visible spectrum.
